(19) United States
(12) Patent Application Publication
(10) Pub. No.: US 2020/0071032 A1
(43) Pub. Date: Mar. 5, 2020

(54) UNIVERSAL BAG SEALER SYSTEM

(71) Applicant: Duc H. Trinh, Las Vegas, NV (US)

(72) Inventor: Duc H. Trinh, Las Vegas, NV (US)

(21) Appl. No.: 16/530,972

(22) Filed: Aug. 2, 2019

Related U.S. Application Data
(60) Provisional application No. 62/765,568, filed on Aug. 31, 2018.

(51) Int. Cl. B65D 33/25; B31B 70/81

(52) U.S. Cl. CPC B65D 33/2508; B31B 70/813

(57) ABSTRACT

A universal bag sealer system including an elongated sealing strip including a front-panel, a rear-panel, a sealing mechanism, pressure-sensitive adhesive sections, and a removeable cover. A cutting tool and a template are provided for use in combination with the elongated sealing strip. A sealing mechanism extends horizontally along a length of the elongated sealing strip. The elongated sealing strip includes a set of locking tracks structured to align and releasably interlock. The rear-panel of the elongated sealing strip is configured to be secured to an exterior surface of a host-bag via the pressure-sensitive adhesive sections forming an airtight seal. Contents of the host-bag may be accessed via opening of the sealing mechanism and alternatively sealed by engaging the sealing mechanism.

### CROSS REFERENCE TO RELATED APPLICATION

The present application is related to and claims priority to U.S. Provisional Patent Application No. 62/765,568 filed Aug. 31, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of containers and bags and more specifically relates to bag sealers.

### 2. DESCRIPTION OF RELATED ART

Plastic and foil bags have long been utilized to hold a variety of items, including food products, therein for transportation and resale. A large number of bags of this type include mechanisms disposed thereon which enable the bag to be opened and resealed in a manner that prevents spoilage or spillage of the contents of the bag. However, many products are provided in non-resealable bags. It is difficult to maintain freshness of items stored with non-resealable bags. It is desirable to develop a bag resealing system which may be utilized with existing non-resealable bags. A suitable solution is required.

U.S. Pub. No. 2007/0269143 to Charles P. Hickey relates to a bag resealing system. The described bag resealing system is capable of being applied to an existing bag structure in order to form a releasable closure thereon. The system includes a support strip of suitable material having an adhesive disposed on one side thereof in order to attach the system to the exterior of a bag and an aperture formed in the support strip. The system also includes a closure mechanism disposed on the support strip opposite the adhesive in an airtight manner completely around the aperture and including a pair of releasably engageable members disposed opposite the adhesive. The attachment of the closure mechanism on the support strip provides clearance between the mechanism and the support strip to enable the mechanism to open and define an opening therein in alignment with the aperture, which enables the mechanism to be selectively opened and closed to expose the aperture in the support strip.

### BRIEF SUMMARY OF THE INVENTION

In view of the foregoing disadvantages inherent in the known containers and bags art, the present disclosure provides a novel universal bag sealer system. The general purpose of the present disclosure, which will be described subsequently in greater detail, is to provide a resealable closure device which may be used to convert a non-resealable bag into a resealable bag to maintain freshness of food items stored within.

A universal bag sealer system is disclosed herein. The universal bag sealer system includes an elongated sealing strip including a front-panel, a rear-panel, a sealing mechanism, pressure-sensitive adhesive sections, and a removeable cover. The front-panel and the rear-panel are opposingly positioned to each other and connected at a first-end and a second-end of the elongated sealing strip forming a slot. The rear-panel of the elongated sealing strip is configured to be secured to an exterior surface of a host-bag via the pressure-sensitive adhesive sections forming an airtight seal when closed (in-use). The sealing mechanism extends horizontally along a length of the elongated sealing strip. The elongated sealing strip comprises a set of locking tracks including male-segments and the female-segments which are configured to align and releasably interlock to form an airtight seal. Alternatively, the set of locking tracks may be disengaged to access contents within a host-bag. The removeable cover is removeable and configured to be removed to expose the pressure-sensitive adhesive sections for use. The universal bag sealer system further comprises a cutting tool and a template for assisting in placement and applying the elongated sealing strip. The cutting tool of the universal bag sealer system allows a user to open host-bags in a format that corresponds with the sealing mechanism of the elongated sealing strip to provide a continuous opening.

A method of installing (and using) an elongated sealing strip to convert a host-bag into a resealable said host-bag is also disclosed herein. The method of using universal bag sealer system may comprise the steps of: providing an elongated sealing strip including a front-panel, a rear-panel, a sealing mechanism, pressure-sensitive adhesive sections, and a removeable cover; step two, removing the removeable cover to expose the pressure-sensitive adhesive sections; step three, applying and securing the elongated sealing strip having a set of locking tracks to a host-bag via the pressure-sensitive adhesive sections; step four, separating the set of locking tracks to form a slot therebetween; step five, cutting an elongated slit in the host-bag along an exposed section between the slot; and optional steps of step six, placing a template on the host-bag; and step seven, removing and disposing of the elongated sealing strip.

A kit is also disclosed including a set of instructions, a cutting tool, at least one elongated sealing strip, and a template.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a universal bag sealer system, constructed and operative according to the teachings of the present disclosure.

FIG. 1 is a perspective view of the universal bag sealer system during an ‘in-use’ condition, according to an embodiment of the disclosure.

FIG. 2 is a perspective view of the universal bag sealer system of FIG. 1, according to an embodiment of the present disclosure.

FIG. 3 is a perspective view of the universal bag sealer system of FIG. 1, according to an embodiment of the present disclosure.

FIG. 4 is a perspective view of the universal bag sealer system of FIG. 1 including a kit, according to an embodiment of the present disclosure.

FIG. 5 is a flow diagram illustrating a method of use for the universal bag sealer system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a containers and bags and more particularly to a universal bag sealer system as used to improve the means for resealing food and other storage bags that do not have sealing methods included in their original structures. The universal bag sealer system prevents air, humidity, and various elements from damaging the quality of the bag's contents to extend the duration in which a user may enjoy contents of the bag.

Generally, the universal bag sealer system includes an apparatus which may be applied to a bag and creates an airtight seal for assisting in maintaining freshness of various items within the bag, while allowing items to effectively remain in their original packaging. The present invention allows an airtight, resealable opening to be easily created and used on bags that commonly store food items such as but not limited to potato chips and dog food for example. The invention features an elongated sealing strip including a front and back panel of durable, clear plastic. The two panels are opposingly positioned to each other with the top of the front panel slightly lower than that of the back panel. The two panels are bonded together at their side edges. The interior surface side of each panel features two sets of corresponding locking tracks that mate to seal the invention. Exterior surfaces of the back panel and side edges of the invention, as well as a strategic-portion of the interior surface of the front panel include a pressure-sensitive adhesive. The adhesive may be protected by wax paper until use. This adhesive (or other ‘indicator’ portion) may change color as the universal bag sealer system is applied to the bag to indicate an airtight seal has been achieved. When the user applies pressure along the edges of the unit to seal it to the food container that pressure causes the glue to change color. The product may be provided in a continuous roll or in individual elongated sealing strip sections. The continuous roll of elongated sealing strips may be cut to a desired length, end portions may then be sealed with an adhesive.

The universal bag sealer system may further include a re-useable template that can be positioned on a food container to assist a user in proper positioning and applying of the elongated sealing strip. This effectively ensures the user doesn't place the product too high or too low on the container. A cutting utensil is further provided with the universal bag sealer system. The cutting utensil may feature a cap to conceal its blade when not in active use, and a magnet upon one side of the handle to allow for storage on a metal surface, such as a refrigerator. The cutting utensil is used to create a slit in the bag which is aligned with the elongated sealing strip such that a user may unseal the locking tracks to access items contained within the bag. The universal bag sealer system allows a user to convert original packaging of food items into a resealable bag. The universal bag sealer system can be used with non-food items that are subject to staleness and/or deterioration after bag opening, such as but not limited to garden fertilizers.

A method of applying the elongated sealing strip may be as follows: a user may place the template on a bag, the wax paper is then removed, and the unit is placed within the area of the template. By pressing on the pressure-sensitive adhesive the elongated sealing strip is secured on the bag near a top edge of the bag. The template may then be removed. The locking tracks of the elongated sealing strip are disengaged to expose a portion of the bag covered by the elongated sealing strip. The cutting utensil is used to cut an opening into said exposed portion. This opening can be sealed by engaging the locking tracks of the invention and accessed by disengaging the locking tracks.

The universal bag sealer system can be produced in various sizes, colors, and shapes. The universal bag sealer system may be made in specific designs intended for use on bags of specific sizes and shapes. The universal bag sealer system can be made of various materials of adequate durability, including but not limited to polyethylene (PE), polypropylene (PP), and linear low-density polyethylene (LLDPE). The separable fastener of the universal bag sealer system may be made in different formats of, and/or include various features with, its fastener category, such as but not limited to wide-track ribs, clicking zipper (zipping fastener), and opposing colors. The universal bag sealer system can be produced in formats intended for commercial use.

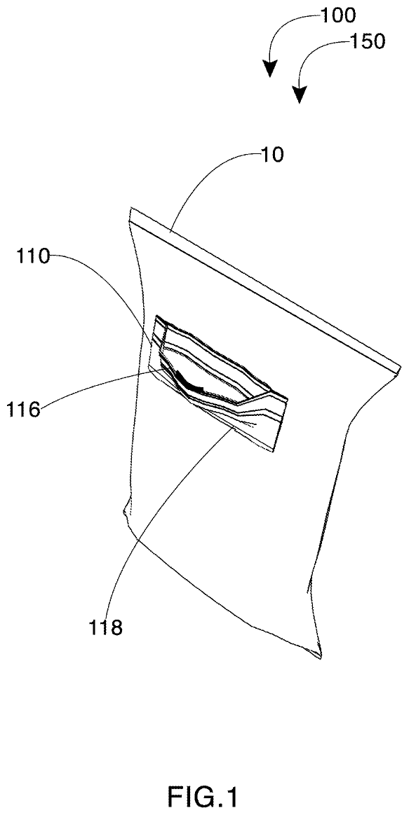

Referring now more specifically to the drawings by numerals of reference, there is shown in FIGS. 1-5, various views of a universal bag sealer system 100. FIG. 1 shows a universal bag sealer system 100 during an ‘in-use’ condition 150, according to an embodiment of the present disclosure. As illustrated, the universal bag sealer system 100 may include an elongated sealing strip 110 including a front-panel 112, a rear-panel 114, a sealing mechanism 116, pressure-sensitive adhesive sections 118, and a wax paper, removeable cover 120 applied over the pressure-sensitive adhesive sections 118.

The front-panel 112 and the rear-panel 114 are opposingly positioned to each other and connected at a first-end 124 and a second-end 126 of the elongated sealing strip 110 forming a slot. The sealing mechanism 116 extends horizontally along a length of the elongated sealing strip 110. The elongated sealing strip 110 comprises a set of locking tracks 128 configured to align and releasably interlock to form an airtight seal. The rear-panel 114 of the elongated sealing strip 110 is configured to be secured to an exterior surface of a host-bag 10 via the pressure-sensitive adhesive sections 118 forming an airtight seal. The removeable cover 120 is removeable and configured to be removed to expose the pressure-sensitive adhesive sections 118 for use. The universal bag sealer system 100 does not require potentially damaging compression upon the contents of the host-bag 10, nor does it restrict the storage area of a bag.

The universal bag sealer system 100 further comprises a template 140 for assisting in proper placement of and applying the elongated sealing strip 110. The template 140 comprises a lightweight paperboard body having a rectangular opening 142 at a center portion of the template 140 and an angular bend 144 positioned at a top edge of the template 140. The rectangular opening 142 has an approximate five and one-quarter inch length by two and one-quarter inch height. The angular bend 144 allows the template 140 to hang upon a host-bag 10.

The universal bag sealer system 100 further comprises a cutting tool 160. The cutting tool 160 of the universal bag sealer system 100 may be made in various sizes and shapes. The cutting tool 160 comprises a blade 148 and a removeable cap 152 for covering the blade 148 during none use. The blade 148 may be retained within a housing 154 of durable polyvinyl chloride (PVC), and projects through an open slot. The cutting tools 160 of the universal bag sealer system 100 allows a user to open host-bags 10 in a functional format that corresponds with the sealing mechanism 116 of the elongated sealing strip 110. The cutting tool 160 of the universal bag sealer system 100 may include a magnet 146 on its structure, or may include other implements for its convenient storage, such as a cord for attachment to a refrigerator or cabinet handle.

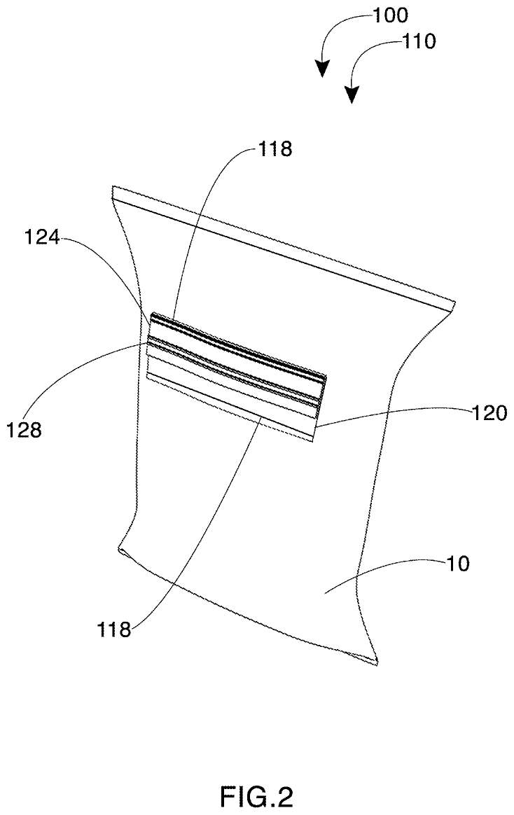

FIG. 2 shows a perspective view of the universal bag sealer system 100 of FIG. 1, according to an embodiment of the present disclosure. As above, the universal bag sealer system 100 may include the elongated sealing strip 110 comprising the front-panel 112 and rear-panel 114 for securing to a host-bag 10 via the pressure-sensitive adhesive sections 118. The front-panel 112 and the rear-panel 114 are opposingly positioned to each other with a top portion of the front-panel 112 being slightly lower than a rear-panel-top-portion of the rear-panel 114. The elongated sealing strip 110 is flexible and configured to contour to the exterior surface of the host-bag 10. The set of locking tracks 128 of the elongated sealing strip 110 comprise male-segments and female-segments. The male-segments and the female-segments are positioned at opposing sides of the slot. In a preferred embodiment, the sealing mechanism 116 measures approximately four and one-third inches (4¼″) in length. The elongated sealing strip 110 may comprise a strip-length of approximately 5 inches and a strip-height of approximately 2 inches. The sealing mechanism 116 of the universal bag sealer system 100 can include a various number of locking tracks 128 which may be made in various levels of tension and durability.

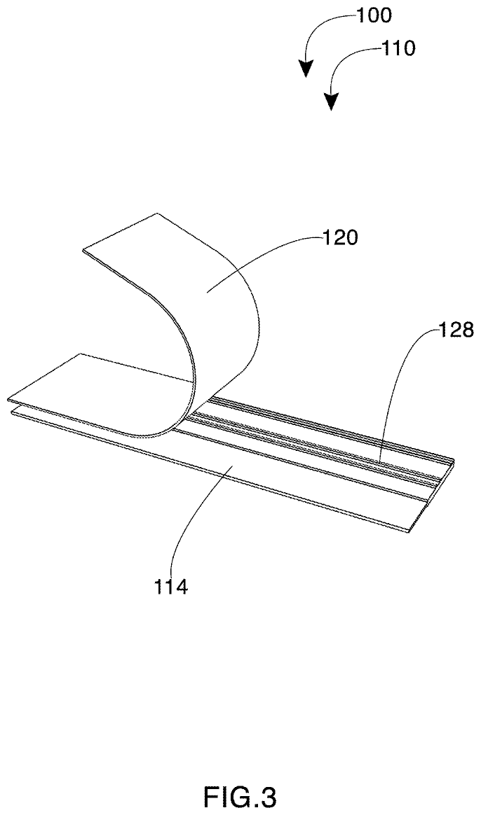

FIG. 3 shows a perspective view of the universal bag sealer system 100 of FIG. 1, according to an embodiment of the present disclosure. As above, the universal bag sealer system 100 may include the elongated sealing strip 110 including the front-panel 112, the rear-panel 114, the sealing mechanism 116, the pressure-sensitive adhesive sections 118, and the removeable cover 120. The front-panel 112 and the rear-panel 114 comprise a flexible, transparent plastic material. The elongated sealing strip 110 may include polyethylene (PE), polypropylene (PP), and/or linear low-density polyethylene (LLDPE) materials.

In a one embodiment, the front-panel 112 further comprises a grasping tab for simplifying a process of opening and closing the sealing mechanism 116 of the elongated sealing strip 110 for access to contents of the host-bag 10 and alternatively sealing the host-bag 10. The pressure-sensitive adhesive sections 118 may include a color-changing adhesive for visual indication of an integrity of the airtight seal. The pressure-sensitive adhesive sections 118 may be infused with various dies, compounds and agents, such as food coloring, to facilitate changing of colors when the unit is applied to a host-bag 10. Various pressure-sensitive adhesives may be featured on a rear-panel 114 of the universal bag sealer system 100, such as but not limited to polyvinyl acetate (PVA), acrylic, and ethylene vinyl acetate (EVA).

In certain embodiments, the elongated sealing strip 110 is provided in a continuous roll. In this embodiment, a user may cut the elongated sealing strip 110 to a desired length and short edges of the elongated sealing strip 110 may be sealed with an included adhesive. In other embodiments, the elongated sealing strips 110 are pre-cut to a length suitable for ready application to a host-bag 10.

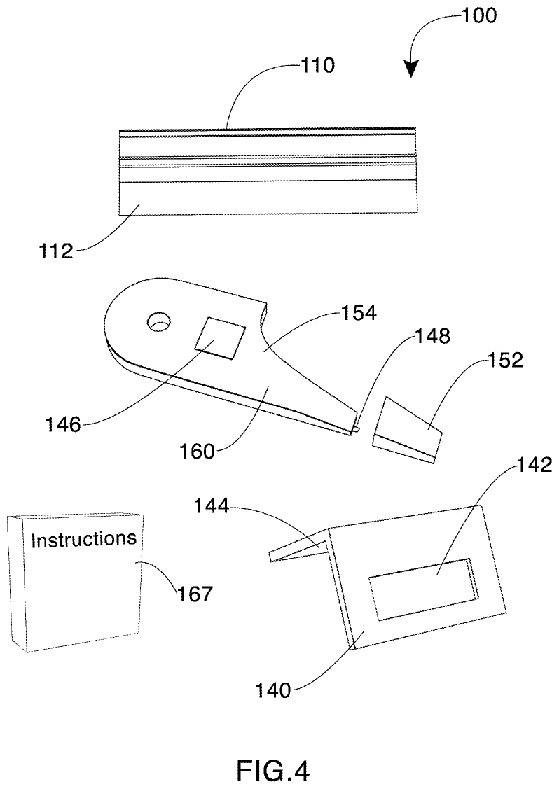

According to one embodiment, the universal bag sealer system 100, as shown in FIG. 4 may be arranged as a kit. The kit may include a set of instructions 162, a cutting tool 160, at least one elongated sealing strip 110, and a template 140. The instructions may detail functional relationships in relation to the structure of the universal bag sealer system 100 (such that the universal bag sealer system 100 can be used, maintained, or the like, in a preferred manner).

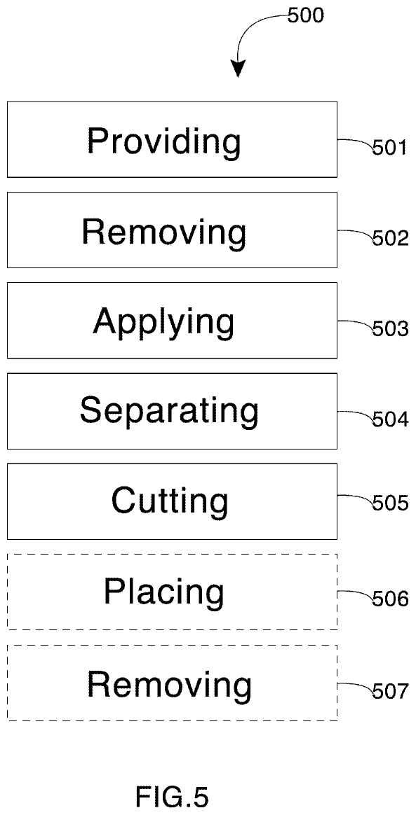

FIG. 5 is a flow diagram 550 illustrating a method of installing an elongated sealing strip to convert a host-bag into a resealable said host-bag 500, according to an embodiment of the present disclosure. As illustrated, the method of installing an elongated sealing strip to convert a host-bag into a resealable said host-bag 500 may include the steps of: step one 501, providing an elongated sealing strip 110 including a front-panel 112, a rear-panel 114, a sealing mechanism 116, pressure-sensitive adhesive sections 118, and a removeable cover 120; step two 502, removing the removeable cover 120 to expose the pressure-sensitive adhesive sections 118; step three 503, applying and securing the elongated sealing strip 110 having a set of locking tracks 128 to a host-bag 10 via the pressure-sensitive adhesive sections 118; step four 504, separating the set of locking tracks 128 to form a slot therebetween; step five 505, cutting an elongated slit in the host-bag 10 along an exposed section between the slot using a cutting tool 160; optionally step six 506, placing a template 140 on the host-bag 10; and step seven 507, removing and disposing of the elongated sealing strip 110.

It should be noted that step six 506 and seven 507 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for universal bag sealer system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A universal bag sealer system comprising:
an elongated sealing strip including;
a front-panel;
a rear-panel;
a sealing mechanism;
pressure-sensitive adhesive sections; and
a removeable cover; and
wherein said front-panel and said rear-panel are opposingly positioned to each other and connected at a first-end and a second-end of said elongated sealing strip forming a slot;
wherein said sealing mechanism extends horizontally along a length of said elongated sealing strip, said elongated sealing strip comprising a set of locking tracks configured to align and releasably interlock to form an airtight seal; and
wherein said rear-panel of said elongated sealing strip is configured to be secured to an exterior surface of a host-bag via said pressure-sensitive adhesive sections forming an airtight seal, said removeable cover is removeable and configured to be removed to expose said pressure-sensitive adhesive sections for use.

2. The universal bag sealer system of claim 1, wherein said elongated sealing strip is flexible and configured to contour to said exterior surface of said host-bag.

3. The universal bag sealer system of claim 1, wherein said front-panel and said rear-panel are opposingly positioned to each other with a top portion of said front-panel being slightly lower than a rear-panel-top-portion of said rear-panel.

4. The universal bag sealer system of claim 1, wherein said set of locking tracks comprise male-segments and female-segments.

5. The universal bag sealer system of claim 4, wherein said male-segments and said female-segments are positioned at opposing sides of said slot.

6. The universal bag sealer system of claim 1, wherein said elongated sealing strip comprises a strip-length of approximately 5 inches and a strip-height of approximately 2 inches.

7. The universal bag sealer system of claim 1, wherein said front-panel and said rear-panel comprise a flexible, transparent plastic material.

8. The universal bag sealer system of claim 7, wherein said front-panel further comprises a grasping tab.

9. The universal bag sealer system of claim 1, wherein said elongated sealing strip is provided in a continuous roll.

10. The universal bag sealer system of claim 1, wherein said pressure-sensitive adhesive sections further comprises color-changing adhesive for visual indication of an integrity of said airtight seal.

11. The universal bag sealer system of claim 1, further comprises a template for assisting in placement and applying said elongated sealing strip.

12. The universal bag sealer system of claim 11, wherein said template comprises a rectangular opening at a center portion of said template and an angular bend positioned at a top edge of said template.

13. The universal bag sealer system of claim 1, further comprises a cutting tool.

14. The universal bag sealer system of claim 13, wherein said cutting tool comprises a blade, said blade being retractable.

15. The universal bag sealer system of claim 14, wherein said cutting tool further comprises a removeable cap configured to cover said blade.

16. The universal bag sealer system of claim 13, wherein said cutting tool further comprises a magnetic fastener.

17. A universal bag sealer system, the universal bag sealer system comprising:
an elongated sealing strip including;
a front-panel;
a rear-panel;
a sealing mechanism;
pressure-sensitive adhesive sections; and
a removeable cover; and
a template for assisting in placement and applying said elongated sealing strip; and
a cutting tool;
wherein said front-panel and said rear-panel are opposingly positioned to each other and connected at a first-end and a second-end of said elongated sealing strip forming a slot;
wherein said front-panel and said rear-panel are opposingly positioned to each other with a top portion of said front-panel being slightly lower than a rear-panel-top-portion of said rear-panel;
wherein said front-panel and said rear-panel comprise a flexible, transparent plastic material;
wherein said front-panel further comprises a grasping tab;
wherein said sealing mechanism extends horizontally along a length of said elongated sealing strip, said elongated sealing strip comprising a set of locking tracks configured to align and releasably interlock to form an airtight seal;
wherein said set of locking tracks comprise male-segments and female-segments;
wherein said male-segments and said female-segments are positioned at opposing sides of said slot;
wherein said rear-panel of said elongated sealing strip is configured to be secured to an exterior surface of a host-bag via said pressure-sensitive adhesive sections forming an airtight seal, said removeable cover is removeable and configured to be removed to expose said pressure-sensitive adhesive sections for use;
wherein said elongated sealing strip is flexible and configured to contour to said exterior surface of said host-bag;
wherein said pressure-sensitive adhesive sections further comprises color-changing adhesive for visual indication of an integrity of said airtight seal;
wherein said template comprises a rectangular opening at a center portion of said template and an angular bend positioned at a top edge of said template;
wherein said cutting tool comprises a blade, said blade being retractable;
wherein said cutting tool further comprises a removeable cap configured to cover said blade; and
wherein said cutting tool further comprises a magnetic fastener.

18. The universal bag sealer system of claim 17, is further arranged as a kit including:
a set of instructions;
a cutting tool;
at least one elongated sealing strip; and
a template.

19. A method of installing an elongated sealing strip to convert a host-bag into a resealable said host-bag, the method comprising the steps of:
providing an elongated sealing strip including;
a front-panel;
a rear-panel;
a sealing mechanism;
pressure-sensitive adhesive sections; and
a removeable cover;
removing said removeable cover to expose said pressure-sensitive adhesive sections;
applying and securing said elongated sealing strip having a set of locking tracks to a host-bag via said pressure-sensitive adhesive sections;
separating said set of locking tracks to form a slot therebetween; and
cutting an elongated slit in said host-bag along an exposed section between said slot.

20. The method of claim 19, further comprising the steps of:
placing a template on said host-bag; and
removing and disposing of said elongated sealing strip.
